(19) United States
(12) Patent Application Publication
(10) Pub. No.: US 2015/0341347 A1
(43) Pub. Date: Nov. 26, 2015

(54) METHODS AND SYSTEMS OF ISSUING, TRANSMITTING AND MANAGING TOKENS USING A LOW-LATENCY SESSION SYNDICATION FRAMEWORK

(71) Applicant: Google Inc., Mountain View, CA (US)

(72) Inventors: Guibin Kong, Mountain View, CA (US); Naveen Agarwal, Mountain View, CA (US)

(73) Assignee: Google Inc., Mountain View, CA (US)

(21) Appl. No.: 14/285,744

(22) Filed: May 23, 2014

(51) Int. Cl. H04L 29/06

(52) U.S. Cl. CPC H04L 63/0853; H04L 63/08

(57) ABSTRACT

A method of implementing session syndication using a low-latency session syndication framework may include receiving, by an inline frame associated with an authorization provider, a request from a client application for an access token. The inline frame may be embedded in the client application. The method may include sending, by the inline frame, a request for the access token to a computing device associated with the authorization provider, receiving, by the inline frame from the authorization provider, an access token associated with one or more resources of the authorization provider, and providing the access token to the client application.

### BACKGROUND

Authorization frameworks, such as OAuth 2.0, enable third-party applications to obtain limited access to a web-based service. For example, a client may want to access a protected resource that belongs to a resource owner. Instead of granting client access via the owner's credentials, access may be granted using a token granted by an authorization server. However, these frameworks typically do not define how the access token should be cached or reused after page reloading. Moreover, these frameworks do not provide session state information, and purge all cached tokens upon logout. In addition, these frameworks make it difficult to support multi-login contexts.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimension recited below. As used herein, the term “comprising” means “including, but not limited to.”

In an embodiment, a method of implementing session syndication using a low-latency session syndication framework may include receiving, by an inline frame associated with an authorization provider, a request from a client application for an access token. The inline frame may be embedded in the client application. The method may include sending, by the inline frame, a request for the access token to a computing device associated with the authorization provider, receiving, by the inline frame from the authorization provider, an access token associated with one or more resources of the authorization provider, and providing the access token to the client application.

In an embodiment, a method of implementing session syndication using a low-latency session syndication framework may include receiving, by an inline frame associated with an authorization provider, a request from a client application for an access token. The inline frame is embedded in the client application. The method may include sending, by the inline frame, a request for the access token to a computing device associated with the authorization provider, receiving, by the inline frame from the authorization provider, an access token associated with one or more resources of the authorization provider, storing the access token in a web storage cache associated with the inline frame, receiving a subsequent access token request from the client application, determining, by the inline frame, whether the stored access token has expired, and determining, by the inline frame, whether to provide the client application access to the stored access token based on whether the stored access token has expired.

In an embodiment, a method of implementing session syndication using a low-latency session syndication framework may include receiving, by an inline frame associated with an authorization provider and embedded in a client application, session information for a user session, storing the session selector in a cache associated with the inline frame, providing one or more contexts of a client application with access to at least a portion of the session information, receiving, by the inline frame, updated session information, determining whether the updated session information differs from the session information, and in response to determining that updated session information differs from the session information, notifying the one or more contexts that the session information has changed.

In an embodiment, a system of implementing session syndication using a low-latency session syndication framework may include a computing device and a computer-readable storage medium in communication with the computing device. The computer-readable storage medium may include one or more programming instructions that, when executed, cause the computing device to receive, by an inline frame associated with an authorization provider, a request from a client application for an access token, where the inline frame is embedded in the client application, send, by the inline frame, a request for the access token to a computing device associated with the authorization provider, receive, by the inline frame from the authorization provider, an access token associated with one or more resources of the authorization provider, and provide the access token to the client application.

In an embodiment, a system of implementing session syndication using a low-latency session syndication framework may include a computing device and a computer-readable storage medium in communication with the computing device. The computer-readable storage medium may include one or more programming instructions that, when executed, cause the computing device to receive, by an inline frame associated with an authorization provider, a request from a client application for an access token, where the inline frame is embedded in the client application, send, by the inline frame, a request for the access token to a computing device associated with the authorization provider, receive, by the inline frame from the authorization provider, an access token associated with one or more resources of the authorization provider, store the access token in a web storage cache associated with the inline frame, receive a subsequent access token request from the client application, determine, by the inline frame, whether the stored access token has expired, and determine, by the inline frame, whether to provide the client application access to the stored access token based on whether the stored access token has expired.

In an embodiment, a system of implementing session syndication using a low-latency session syndication framework may include a computing device and a computer-readable storage medium in communication with the computing device. The computer-readable storage medium may include one or more programming instructions that, when executed, cause the computing device to receive, by an inline frame associated with an authorization provider and embedded in a client application, session information for a user session, store the session selector in a cache associated with the inline frame, provide one or more contexts of a client application with access to at least a portion of the session information, receive, by the inline frame, updated session information, determine whether the updated session information differs from the session information, and in response to determining that updated session information differs from the session information, notify the one or more contexts that the session information has changed.

### BRIEF DESCRIPTION OF THE DRAWINGS

FIG. 1 illustrates an example system for authenticating web users according to an embodiment.

FIG. 2 illustrates an example session syndication flow for a low-latency session syndication framework according to an embodiment.

FIG. 3 illustrates an example method of storing an access token according to an embodiment.

FIG. 4 illustrates an example method of storing a session information according to an embodiment.

FIG. 5 illustrates a block diagram of example hardware that may be used to contain or implement program instructions according to an embodiment.

FIG. 6 illustrates a diagram showing an example method of handling a session change for multiple widgets according to an embodiment.

FIG. 7 illustrates an example architecture for using an authorization provider iframe to relay authorization results according to an embodiment.

FIG. 8 illustrates example components of an architecture for using an authorization provider iframe according to an embodiment.

FIG. 9 illustrates a graphical representation of a low-latency session syndication framework according to an embodiment.

### DETAILED DESCRIPTION

The following terms shall have, for purposes of this application, the respective meanings set forth below:

An “access token” or “token” refers to a string that can be used to access information from an authorization provider. An access token may identify a particular user, privileges and/or the like.

A “client” may be any program that receives and/or accesses session information of a server. Example clients may include, without limitation, an application that runs in a web browser, an application installed on a computing device, hardware programs and/or the like.

A “computing device” refers to a device that includes a processor and tangible, computer-readable memory. The memory may contain programming instructions that, when executed by the processor, cause the computing device to perform one or more operations according to the programming instructions. Examples of computing devices include personal computers, servers, mainframes, gaming systems, televisions, and portable electronic devices such as smartphones, personal digital assistants, cameras, tablet computers, laptop computers, media players and the like. When used in the claims, reference to “a computing device” may include a single device, or it may refer to any number of devices having one or more processors that communicate with each other and share data and/or instructions to perform the claimed steps.

An “inline frame” or “iframe” refers to a web-based document, such as an HTML document, that is embedded inside another web-based document, such as another HTML document, on a website.

A “server” refers to any program that generates, transmits, syndicates, and/or manages session information. For example, a server may be a computing device, a browser or other program.

In an embodiment, one or more tokens may be issued, transmitted and/or managed using a low-latency session syndication framework. A low-latency session syndication framework may allow server session state information to be syndicated by one or more interested clients. A low-latency session syndication framework may support multi-login contexts as a server may have multiple active sessions.

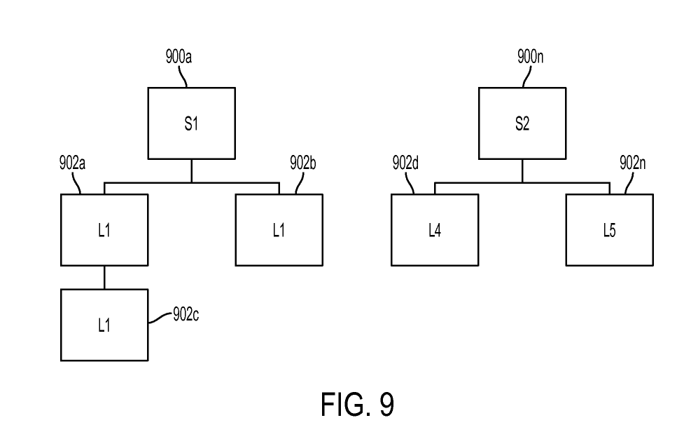

FIG. 9 illustrates a graphical representation of a low-latency session syndication framework according to an embodiment. As illustrated by FIG. 9, the framework may include one or more servers 900a-N and one or more clients 902a-N. A server may be any program that generates, transmits and/or syndicates session information. For example, a server may be a browser or other program. A client may be any program that accesses session information from a server. For example, a client may be a JavaScript or other application that runs in a web browser. As another example, a client may be an application that may be downloaded and/or installed on a mobile device, a tablet computing device or another computing device. As another example, a client may be certain hardware programs.

In an embodiment, a low-latency session syndication framework may utilize named session selectors. Multiple session selectors may be defined and may coexist without interference to one another.

In certain embodiments, a client may choose which session selector to listen to. For instance, a client may make request that a server permit it to act as a listener for a certain session selector. The server may approve or deny the request. This approach allows both a server and a client to enforce security and/or privacy policies.

As illustrated by FIG. 9, listeners (clients who are listening to the syndication of session information from a server) may be cascaded. For example, listener L1 may listen on server S1 and may broadcast session state information to its listener, L2. Accordingly, L2 may indirectly listen on S1.

In certain embodiments, a low-latency session syndication framework may be used to perform session syndication across multiple computing devices, across different layers in a computing device, across multiple web sites in the same browser, and/or the like. For instance, when a user switches session state or selection on one computing device, one or more other computing devices in the area, such as, for example, a mobile device, a television, and/or the like may be notified, and their session information may be changed to that of the computing device. For example, if a user changes session state on his tablet, session information for a mobile device and a television in the same room may be updated as well.

As another example, when a user switches session state or selection in an installed application on his mobile device, one or more other installed applications on the mobile device may automatically be changed to the new session so the user does not need to change session selection on each of his applications one by one.

As yet another example, in an Open Authentication (OAuth) context, relying parties may sync to the session state of an identity provider as described in more detail below.

A system that uses a low-latency session syndication framework may issue, transmit, cache and/or otherwise manage tokens in a more secure and high performance manner.

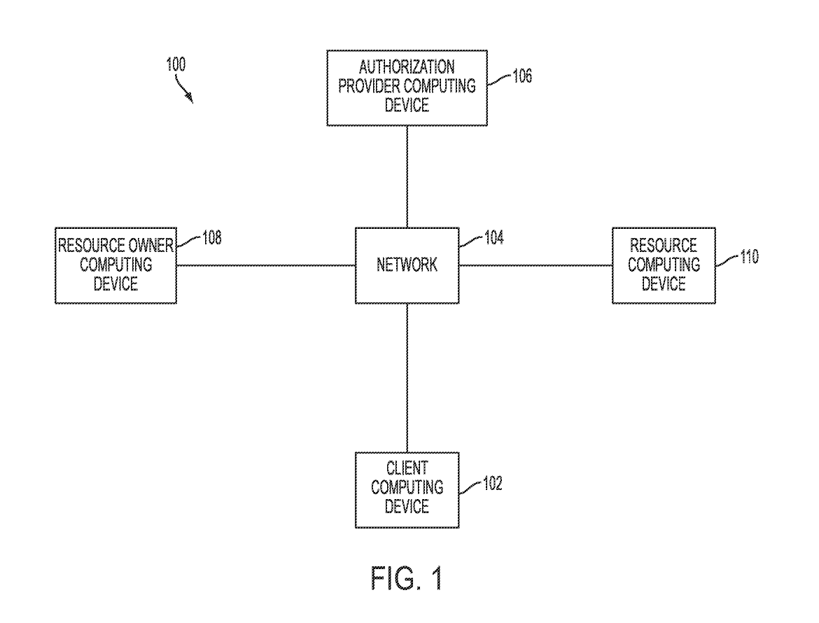

FIG. 1 illustrates an example system 100 for authenticating web users according to an embodiment. As illustrated by FIG. 1, the system 100 may include a client computing device 102, a network 104, an authorization provider computing device 106, a resource owner computing device 108, and a resource computing device 110. Although the system 100 is described in terms of authenticating requests for accessing a web page, it is understood that the system may authenticate additional and/or alternate requests for other information resources within the scope of this disclosure. For example, the system 100 may authenticate requests for any resource that is identified by a Uniform Resource Identifier “URI”) such as, for example, an image, a video and/or the like.

In an embodiment, a client computing device 102 may be a computing device that is associated with a system or application that desires access to a user resource. For instance, a social networking site (client) may desire access to photos (user resource) that belong to a user (resource owner) that are stored by a photo publishing service (resource computing device). In this example, a client computing device 102 may be a computing device associated with the social networking site.

In an embodiment, a client computing device 102 may communicate with an authorization provider computing device 106, a resource owner computing device 108 and/or a resource computing device 110. A client computing device 102 may communicate with an authorization provider computing device 106, a resource owner computing device 108 and/or a resource computing device 110 via a network 104. A network 104 may be a local area network (LAN), a wide area network (WAN), a mobile or cellular communication network, an extranet, an intranet, the Internet and/or the like.

In an embodiment, a resource owner computing device 108 may be a computing device associated with the owner of one or more resources to be accessed. A resource computing device may be a computing device associated with a system or application where one or more protected resources reside. For instance, referring to the above example, a resource computing device may be a computing device associated with the photo publishing service. In an embodiment, an authorization provider computing device 106 may be a computing device associated with a service or application that authenticates the client.

In certain embodiments, the system may utilize one or more browsers. A browser may be a software application that is operable to request, process, and display one or more information resources. For example, a user may enter a URI associated with a web page in the address bar of a browser, which may cause the browser to request, process, and display the web page. In an embodiment, the browser may allow a user to interact with a web page that has been loaded in the browser. For example, a user may enter one or more authentication credentials in a web page of a browser to authenticate the user. A browser may access the World Wide Web or information in other networks.

In an embodiment, a browser 110 use one or more inline frames (iframes). An iframe may be a web-based document, such as an HTML document, that is embedded inside another web-based document, such as another HTML document, on a website. An iframe may be used to insert content from another source into a web page. An iframe's content may be changed without requiring reloading of the surrounding page. Iframes may be used to embed one or more interactive applications in a web page. For instance, a web page associated may include an iframe via which a user may access an account such as, for example, an email account, a social media account and/or the like. In an embodiment, an iframe may be a window in a browser that may request, process and/or display one or more information sources associated with a URI. For instance, a child frame may be an iframe that is embedded in a parent frame.

In certain embodiments, the OAuth framework may be used to authenticate users and/or resource requests. OAuth may allow a user to authorize third-party access to certain server resources without providing the third-party with his or her credentials, such as a username, a password and/or the like. For example, a user may grant a social networking site with access to the user's email account without sharing the user's email account login credentials with the social networking site.

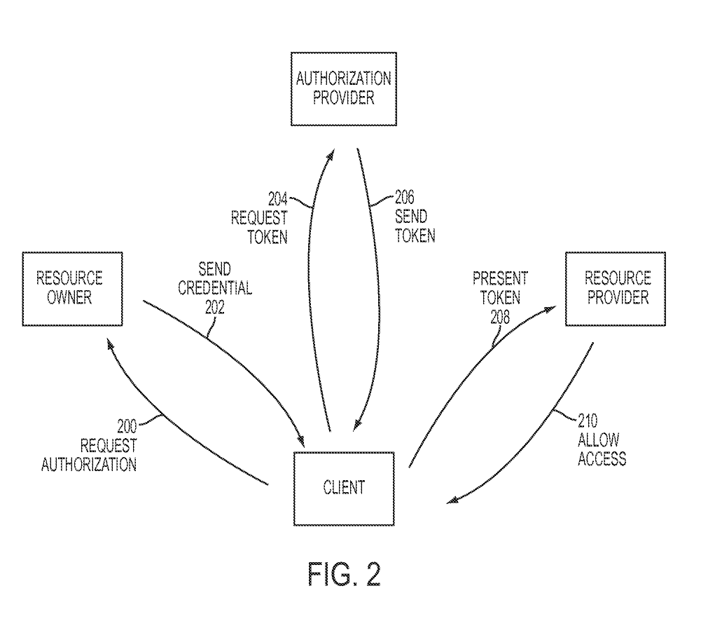

FIG. 2 illustrates an example session syndication flow for a low-latency session syndication framework according to an embodiment. As illustrated by FIG. 2, a client may request 200 authorization from a resource owner in order to access one or more protected resources. In an embodiment, a client may be a system or application that wants to access one or more protected resources of a user. In an OAuth context, a client may be considered a relying party (RP) that may want to authenticate or verify one or more user credentials. In an embodiment, an RP or an RP application may be a system or application that consumes one or more access tokens that are issued by an authorization provider, and uses the tokens to perform one or more identity-related functions, tasks, operations and/or the like.

If the resource owner approves the request, it may send 202 a credential representing its authorization to the client. The client may request 204 an access token from a server, such as on authorization server, by presenting the received credential to an authorization provider. In an embodiment, in an OAuth context, an authorization provider and/or server may be considered an identity provider (IDP). An IDP may be a system that hosts one or more applications that authenticates a user to one or more relying party applications.

The authorization provider may authenticate the client computing device and may validate the credential. If the credential is valid, the authorization provider may issue an access token, and may send 206 the access token to the client. The token may be revokable, and may be issued with a restricted scope and/or duration. The client may then request access to the protected resource by presenting 208 the access token to a resource provider. The resource provider may then allow 210 the client access to the protected resource.

For instance, using the above example, an email account provider may use OAuth to authorize requests by third party clients, such as a social networking site, to access email account resources on behalf of a user. The user may grant permission to the social networking site to access resources, such as a contact list, on behalf of the user. For example, a web site associated with the social networking site may include an iframe that requires the social networking site to access a contact list from the email account provider. When a browser displays the web site, the social networking site may contact a server or other computing device associated with the email account provider to access the resources on behalf of the user. When the site obtains data from the email account provider, it may display the contents in the iframe.

In this situation, the social networking site may be considered a client since it is seeking access to protected resources of a user, whereas the email account provider may be consider a server or authorization server since it is authenticating a user. As such, a client may use iframe associated with an authorization server.

In the authentication process illustrated by FIG. 2, the access token issued by the authorization provider computing device may be stored by the client. For example, a client may store an access token in a local cache. However, the client may be required to obtain a new access token from the authorization provider in certain situations. For example, a client may be required to obtain a new access token from an authorization provider if the received access token expires, if the current session ends, if an associated web page is reloaded, refreshed and/or the like. Obtaining a new token increases application latency and traffic to the authorization provider.

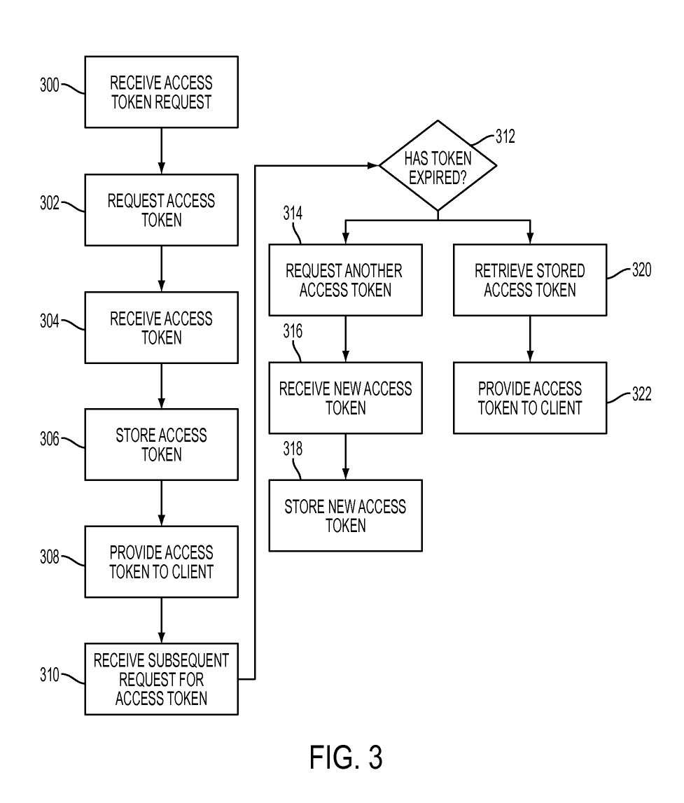

Rather than storing an access token in a local cache, a system may store an access token in a cache associated with an authorization provider iframe. This may allow an access token to be used by a client after the occurrence of certain events, such as a page reload. FIG. 3 illustrates an example method of storing an access token according to an embodiment. An iframe that is associated with an authorization provider may be embedded into a client, such as, for example, a web page. For example, a news web page may include an embedded iframe that is associated with a service provider. A user may log into the user's account with the service provider via the embedded iframe of the news web page.

As illustrated by FIG. 3, an iframe may receive 300 a request for an access token from a client. The iframe may in turn request 302 an access token associated with one or more resources from the authorization provider. In certain embodiments, a user may verify that the client has permission to use the access token before the authorization provider sends the access token to the iframe. The iframe may receive 304 the access token from the authorization provider. The iframe may store 306 the received access token. In an embodiment, the iframe may store 306 the access token in a web storage cache associated with the iframe.

In a embodiment, the iframe may provide 308 the access token to the client. For instance, referring to the above example, a user may login into the user's account with the service provider via the embedded iframe of the news web page. The news web page may request an access token from the iframe. The iframe may then request and receive an access token from the service provider. The iframe may store the received access token, and provide the access token to the news web page.

In an embodiment, a subsequent request for an access token may be received 310 by an iframe from a client. For example, a subsequent request may be in response to a reload request of the client or another access token request.

In response to receiving the subsequent request, the iframe may determine 312 whether the stored access token has expired. If the stored access token has expired, the iframe may not provide the stored access token to the client application. In various embodiments, if the stored access token has expired, the iframe may request 314 another access token from the authorization provider. The iframe may receive 316 a new access token from a computing device associated with the authorization provider. The iframe may store 318 the new access token in its cache in place of the previous access token.

In various embodiments, if the iframe determines that the stored access token has not expired, the iframe may retrieve 320 the stored access token from its cache and may provide 322 the stored access token to the client application.

To work well with a multi-login approach, a client may maintain the same session information, such as session selector, across all client contexts, such as sub-domains, so that an end user can bind to the same account across client contexts. A session selector may be information associated with a particular session, and a context may include, for example, a tab, a client, a page, a sub-domain and/or the like. In an embodiment, a session selector may represent a session selection in multi-login context.

In an embodiment, an authorization provider iframe may allow a client to read and/or write the session selector under current origin or an ancestor domain. A session selector may be shared by one or more client contexts, and may be used for cross-context communication. To support cross-communication, a client may maintain the same session selector across all contexts.

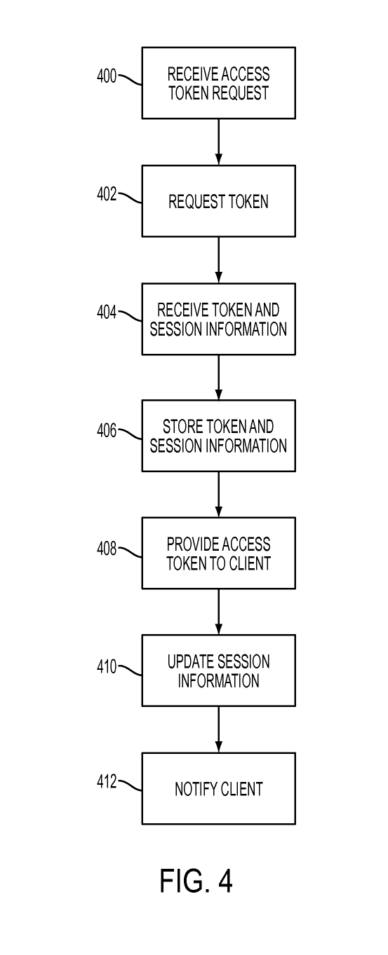

FIG. 4 illustrates an example method of storing session information according to an embodiment. In certain embodiments, a user may have two or more accounts with an authorization provider. A user may log into multiple authorization provider accounts simultaneously. The user may also log into one of the accounts via an iframe that is embedded into a client. As illustrated by FIG. 4, the iframe may receive 400 a request from the client for an access token. The iframe may request 402 a token from the authorization provider. The iframe may receive 404 from the authorization provider the access token and session information. In an embodiment, the session information may include a session selector for the current session, one or more cookies and/or other session identifiers. The iframe may store 406 the access token and/or the session information. In an embodiment, the iframe may store 406 the access token in a web storage cache associated with the iframe. In an embodiment, the iframe may provide 408 the access token to the client.

In an embodiment, if the session information changes, the iframe may update 410 the stored session information, and may notify 412 the client. For example, a user may log into two different service provider accounts, Account 1 and Account 2. The user may log into Account 1 via an iframe that is embedded in a news website. The news website may listen to a session selector associated with Account 1. If the session information changes, the iframe may notify 412 the client. For instance, the user may log out of Account 1 via a web page associated with the service provider. The iframe may request updated session information from the authorization provider, and may store the updated session information that it receives. If the updated session information is different than the previously-stored session information, the iframe may notify the client that the session information has changed. In an embodiment, one or more contexts of the client may be notified 412. For example, one or more client contexts that are listening to the corresponding session selector may be notified 412. As such, a generalized cross-tab communication may be supported. If one tab changes the shared session selector, other tabs that use the same session selector will be notified. Saving session selectors in web storage and triggering a notification event when it is changed provides a common approach to handle a session change.

For example, if the user logs out of Account 1 via a web page associated with the service provider, the news website may be notified, and the user may be automatically signed out of the news website as well. As another example, if the user subsequently logs back into Account 1 via a web page associated with the service provider, the user may automatically be logged back into the news website, so long as the user has approved such an automatic login, and the news website is still listening to the session selector associated with Account 1.

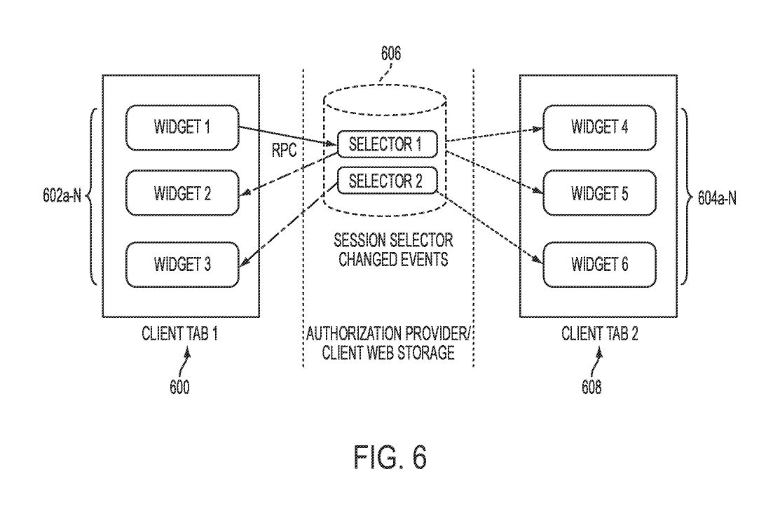

FIG. 6 illustrates a diagram showing an example method of handling a session change for multiple widgets according to an embodiment. A widget may be a software application. In an embodiment, a widget may be integrated within a client context. For instance, a widget may be integrated within a client tab. A widget may be visually represented as one or more icons, menus, buttons, selection boxes and/or the like.

As illustrated by FIG. 6, a first client tab (Client Tab 1 600) may include one or more widgets 602a-N. A second client tab (Client Tab 2 608) may include one or more widgets 604a-N. A session selector provider 606 may communicate with Client Tab 1 600 and Client Tab 2 608. A session selector provider 606 may be a service or library that maintains one or more session selectors. Clients may be able to listen on a session selector, receive and/or set a value of a session selector and/or add a new session selector via the session selector provider 606. If the value of a session selector changes, all listeners may be notified.

As illustrated by FIG. 6, the session selector provider 606 may reside in web storage that is located on the authorization provider or the client side, and may maintain one or more session selectors. The widgets 602a-N, 604a-N from either tab may listen to session selectors of the session selector provider 606. One or more session selector change events may be communicated to one or more widgets 602a-N, 604a-N from the session selector provider 616 according to an embodiment. By defining a common way to manipulate session selectors, no glue code may be needed for session selection when integrating multiple widgets.

In an embodiment, an authorization provider iframe may be used to relay an authorization result. For instance, an authorization provider approval page may send an authorization result via a storage-event-based cross-tab communication. In an embodiment, an authorization result may be an indication of whether a certain request has been authorized. According to various embodiments, a relying party may notify an authorization provider that a storage-based inline frame communicating system may be used to return an authorization result. For instance, a relying party may so notify an authorization provider by including a particular schema or parameter in a URL or other request to the authorization provider. For example, in certain embodiments, OAuth redirect_uri may be extended to support a localstorage://schema.

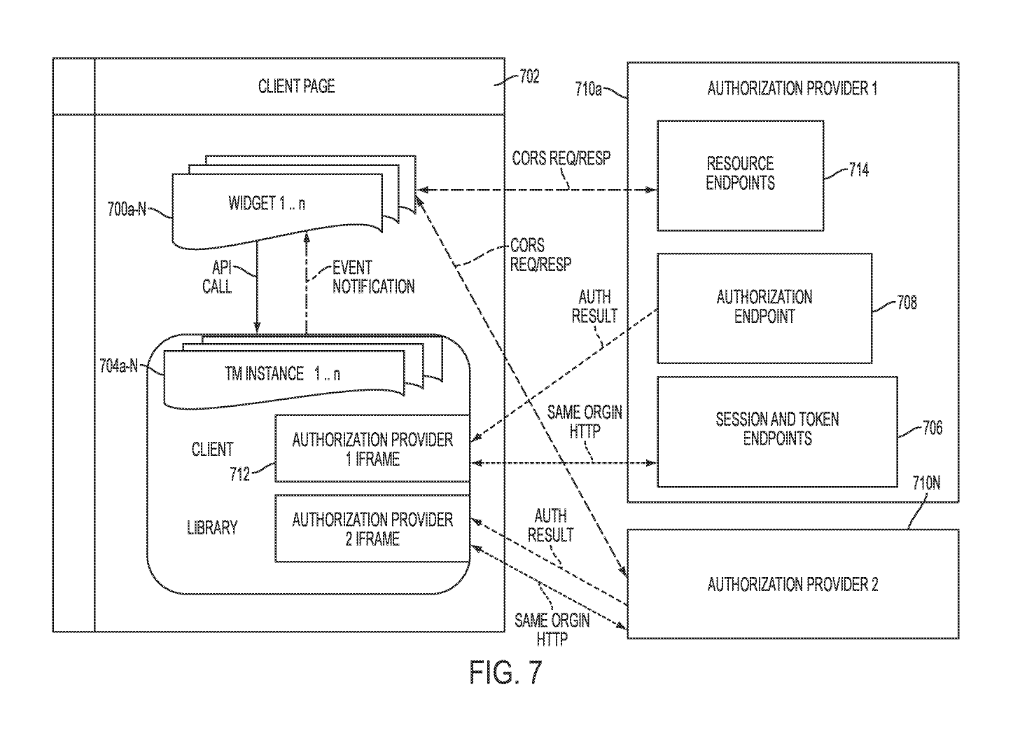

FIG. 7 illustrates an example architecture for using an authorization provider iframe to relay authorization results according to an embodiment. As illustrated by FIG. 7, a client page 702 may communication with one or more authorization providers 710a-N. Multiple widgets or other applications 700a-N may exist on a single client page 702. Each widget or other application 700a-N may construct a Token Manager (TM) instance 704a-N. The TM instances 704a-N may share one or more components in a client library. For example, only one authorization provider iframe, for the same authorization provider, may be used.

As illustrated by FIG. 7, an authorization provider may include one or more endpoints. An endpoint may provide clients, such as OAuth clients, with the ability to communicate with one or more computing devices. An endpoint may be represented by a uniform resource locator other identifier.

Session and Token Endpoints 706 of an authorization provider 710a may include one or more endpoints that feed session information or grant access tokens for a corresponding authorization provider iframe 712. These endpoints 706 may only be accessed from the same origin iframe 712.

In an embodiment, an authorization result page on an Authorization Endpoint 708 may trigger a storage event, and may pass the authorization result to the authorization provider iframe 712 as illustrated by FIG. 7. The authorization provider iframe 712 may then convey the authorization result to the target client 700a-N through an event. Each TM instance 704a-N may maintain a valid access token which may be used by the client 700a-N to retrieve one or more resources from Resource Endpoints 714 of an authorization provider 710a.

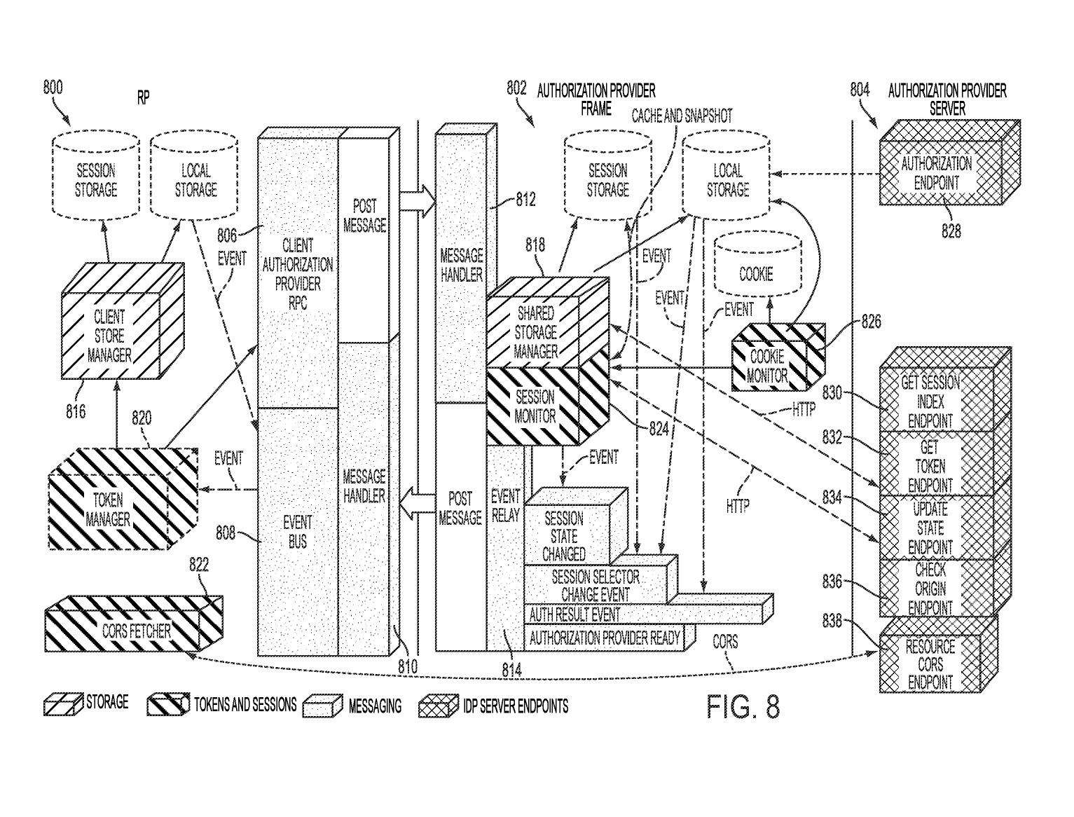

FIG. 8 illustrates example components of an architecture for using an authorization provider iframe according to an embodiment. One or more of the components may be implemented as hardware, software or a combination of hardware and software according to various embodiments. FIG. 8 illustrates example components of a client 800, an authorization provider iframe 802 and an authorization provider server 804. As illustrated by FIG. 8, four types of components may be utilized. Messaging components may provide cross-iframe (authorization provider and client) remote procedure calls. Example messaging components, as illustrated by FIG. 8, may include, without limitation, a client authorization provider RPC 806, an event bus 808, a message handler 810 associated with the client, a message handler 812 associated with the authorization provider iframe, and an event relay 814.

Storage manager components may read and/or write data in web storage and/or filter storage events. Storage manager components may maintain a rule to transform certain metadata, such as, for example, a domain, a client identifier and/or the like, to and/or from a web storage key. Example storage manager components, as illustrated by FIG. 8, may include, without limitation, a client storage manager 816 and a shared storage manager 818.

Token & Session components may be those components that are directly related to session and token management. Example Token & Session components, as illustrated by FIG. 8, may include, without limitation, a token manager 820 (which may have multiple instances), a CORS Fetcher 822, a session monitor 824, and a cookie monitor 826.

Authorization provider server endpoints may be components in the authorization provider server side that feed session information, refresh access tokens and/or the like. Example authorization provider server endpoints, as illustrated by FIG. 8, may include, without limitation, an authorization endpoint 828, a get session index endpoint 830, a get token endpoint 832, an update state endpoint 834, a check origin endpoint 836, and a resource CORS endpoint 838.

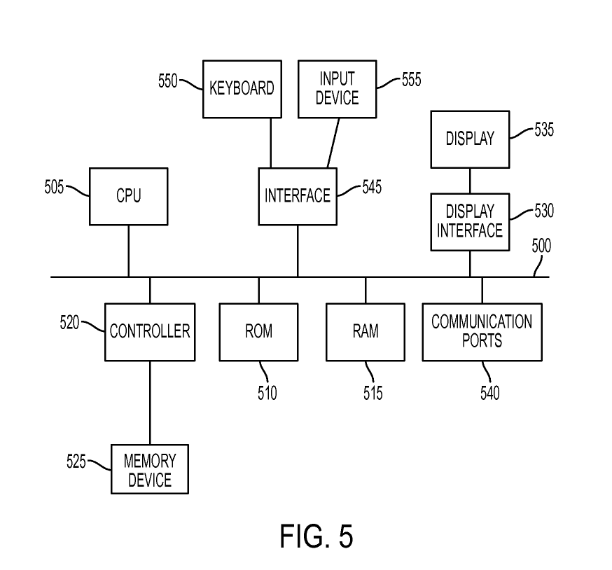

FIG. 5 depicts a block diagram of hardware that may be used to contain or implement program instructions. A bus 500 serves as the main information highway interconnecting the other illustrated components of the hardware. CPU 505 is the central processing unit of the system, performing calculations and logic operations required to execute a program. CPU 505, alone or in conjunction with one or more of the other elements disclosed in FIG. 5, is an example of a production device, computing device or processor as such terms are used within this disclosure. Read only memory (ROM) 510 and random access memory (RAM) 515 constitute examples of non-transitory computer-readable storage media.

A controller 520 interfaces with one or more optional non-transitory computer-readable storage media 525 to the system bus 500. These storage media 525 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 510 and/or the RAM 515. Optionally, the program instructions may be stored on a tangible, non-transitory computer-readable medium such as a compact disk, a digital disk, flash memory, a memory card, a USB drive, an optical disc storage medium and/or other recording medium.

An optional display interface 530 may permit information from the bus 500 to be displayed on the display 535 in audio, visual, graphic or alphanumeric format. Communication with external devices, such as a printing device, may occur using various communication ports 540. A communication port 540 may be attached to a communication network, such as the Internet or an intranet.

The hardware may also include an interface 545 which allows for receipt of data from input devices such as a keyboard 550 or other input device 555 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications or combinations of systems and applications. Also that various presently unforeseen or unanticipated alternatives, modifications, variations or improvements therein may be subsequently made by those skilled in the art which are also intended to be encompassed by the following claims.

What is claimed is:

1. A method of implementing session syndication using a low-latency session syndication framework, the method comprising:
receiving, by an inline frame associated with an authorization provider, a request from a client application for an access token, wherein the inline frame is embedded in the client application;
sending, by the inline frame, a request for the access token to a computing device associated with the authorization provider;
receiving, by the inline frame from the authorization provider, an access token associated with one or more resources of the authorization provider; and
providing the access token to the client application.

2. The method of claim 1, further comprising storing the access token in a web storage cache associated with the inline frame.

3. The method of claim 2, further comprising:
receiving a subsequent access token request from the client application;
determining, by the inline frame, whether the stored access token has expired; and
determining, by the inline frame, whether to provide the client application access to the stored access token based on whether the stored access token has expired.

4. A method of implementing session syndication using a low-latency session syndication framework, the method comprising:
receiving, by an inline frame associated with an authorization provider, a request from a client application for an access token, wherein the inline frame is embedded in the client application;
sending, by the inline frame, a request for the access token to a computing device associated with the authorization provider;
receiving, by the inline frame from the authorization provider, an access token associated with one or more resources of the authorization provider;
storing the access token in a web storage cache associated with the inline frame;
receiving a subsequent access token request from the client application;
determining, by the inline frame, whether the stored access token has expired; and
determining, by the inline frame, whether to provide the client application access to the stored access token based on whether the stored access token has expired.

5. The method of claim 4, wherein:
determining whether to provide access comprises determining to provide access to the stored access token to the client application in response to determining that the stored access token has not expired, and
the method further comprises providing the client application access to the stored access token.

6. The method of claim 4, wherein determining whether to provide the client application access to the stored access token comprises determining that the access token should not be provided to the client in response to determining that the stored access token has expired.

7. The method of claim 4, further comprising:
in response to determining that the stored access token has expired:
sending, by the inline frame, a request for a new access token to the authorization provider,
receiving, by the inline frame, the new access token from the authorization provider, and
replacing the stored access token with the new access token in the web storage cache.

8. The method of claim 4, wherein the client application does not have direct access to the stored access token.

9. A method of implementing session syndication using a low-latency session syndication framework, the method comprising:
receiving, by an inline frame associated with an authorization provider and embedded in a client application, session information for a user session;
storing the session selector in a cache associated with the inline frame;
providing one or more contexts of a client application with access to at least a portion of the session information;
receiving, by the inline frame, updated session information;
determining whether the updated session information differs from the session information; and
in response to determining that updated session information differs from the session information, notifying the one or more contexts that the session information has changed.

10. The method of claim 9, wherein the plurality of contexts comprise one or more of the following:
a client;
a sub-domain; and
a tab.

11. A system of implementing session syndication using a low-latency session syndication framework, the system comprising:
a computing device; and
a computer-readable storage medium in communication with the computing device, wherein the computer-readable storage medium comprises one or more programming instructions that, when executed, cause the computing device to:
receive, by an inline frame associated with an authorization provider, a request from a client application for an access token, wherein the inline frame is embedded in the client application,
send, by the inline frame, a request for the access token to a computing device associated with the authorization provider,
receive, by the inline frame from the authorization provider, an access token associated with one or more resources of the authorization provider, and
provide the access token to the client application.

12. The system of claim 11, wherein the computer-readable storage medium further comprises one or more programming instructions that, when executed, cause the computing device to store the access token in a web storage cache associated with the inline frame.

13. The system of claim 12, wherein the computer-readable storage medium further comprises one or more programming instructions that, when executed, cause the computing device to:
receive a subsequent access token request from the client application;
determine, by the inline frame, whether the stored access token has expired; and
determine, by the inline frame, whether to provide the client application access to the stored access token based on whether the stored access token has expired.

14. A system of implementing session syndication using a low-latency session syndication framework, the system comprising:
a computing device; and
a computer-readable storage medium in communication with the computing device, wherein the computer-readable storage medium comprises one or more programming instructions that, when executed, cause the computing device to:
receive, by an inline frame associated with an authorization provider, a request from a client application for an access token, wherein the inline frame is embedded in the client application,
send, by the inline frame, a request for the access token to a computing device associated with the authorization provider,
receive, by the inline frame from the authorization provider, an access token associated with one or more resources of the authorization provider,
store the access token in a web storage cache associated with the inline frame,
receive a subsequent access token request from the client application,
determine, by the inline frame, whether the stored access token has expired, and
determine, by the inline frame, whether to provide the client application access to the stored access token based on whether the stored access token has expired.

15. The system of claim 14, wherein:
the one or more programming instructions that, when executed, cause the computing device to determine whether to provide access comprise one or more programming instructions that, when executed, cause the computing device to determine to provide access to the stored access token to the client application in response to determining that the stored access token has not expired, and
the computer-readable storage medium further comprises one or more programming instructions that, when executed, cause the computing device to provide the client application access to the stored access token.

16. The system of claim 14, wherein the one or more programming instructions that, when executed, cause the computing device to determine whether to provide the client application access to the stored access token comprise one or more programming instructions that, when executed, cause the computing device to determine that the access token should not be provided to the client in response to determining that the stored access token has expired.

17. The system of claim 14, wherein the computer-readable storage medium further comprises one or more programming instructions that, when executed, cause the computing device to:
in response to determining that the stored access token has expired:
send, by the inline frame, a request for a new access token to the authorization provider,
receive, by the inline frame, the new access token from the authorization provider, and
replace the stored access token with the new access token in the web storage cache.

18. The system of claim 14, wherein the client application does not have direct access to the stored access token.

19. A system of implementing session syndication using a low-latency session syndication framework, the system comprising:
a computing device; and
a computer-readable storage medium in communication with the computing device, wherein the computer-readable storage medium comprises one or more programming instructions that, when executed, cause the computing device to:
receive, by an inline frame associated with an authorization provider and embedded in a client application, session information for a user session,
store the session selector in a cache associated with the inline frame,
provide one or more contexts of a client application with access to at least a portion of the session information,
receive, by the inline frame, updated session information,
determine whether the updated session information differs from the session information, and
in response to determining that updated session information differs from the session information, notify the one or more contexts that the session information has changed.

20. The system of claim 19, wherein the plurality of contexts comprise one or more of the following:
a client;
a sub-domain; and
a tab.
